(19) United States
(12) Patent Application Publication
(10) Pub. No.: US 2008/0025437 A1
(43) Pub. Date: Jan. 31, 2008

(54) Quadrature bandpass-sampling delta-sigma communication receiver

(75) Inventor: Phuong Huynh, Annandale, VA (US)

Correspondence Address: POSZ LAW GROUP, PLC, 12040 SOUTH LAKES DRIVE, SUITE 101, RESTON, VA, 20191, US

(73) Assignee: Phuong T. Huynh, Annandale, VA (US)

(21) Appl. No.: 11/495,683

(22) Filed: Jul. 31, 2006

(51) Int. Cl. H04L 27/00; H04L 27/22

(52) U.S. Cl. 375/324; 375/332; 329/304

(57) ABSTRACT

A quadrature bandpass-sampling analog-to-digital demodulator (QBS-ADD) is provided. A radio frequency (RF) signal is received by a junction summer, which subtracts an in-phase feedback signal and a quadrature feedback signal from the RF signal to produce an error signal. The error signal is then bandpassed and amplified by the RF bandpass filter/amplifier. The amplified signal is bandpass-sampled by two low-resolution analog-to-digital converters clocking in quadrature, and is demodulated and converted into a digital in-phase signal and a digital quadrature signal. The down converted in-phase and quadrature signals are multiplied with two quadrature clocks. The results are converted to two analog signals and fed back to the RF input at the junction summer.

### FIELD OF THE INVENTION

The present invention relates in general analog-to-digital conversion in communication systems. More specifically, the invention relates to analog-to-digital demodulation of a signal at radio frequency in a communication system.

### BACKGROUND OF THE INVENTION

Wireless systems are becoming a fundamental mode of telecommunication in modern society. In order for wireless systems to continue to penetrate into the telecommunications market, the cost of providing the service must continue to decrease and the convenience of using the service should continue to increase. In response to increasing market demand, radio standards around the world have been proliferated based upon digital modulation schemes. Consequently, it is often advantageous to have a receiver that is capable of communication using more than one of these standardized techniques. In order to do so, it is necessary to have a receiver that is capable of receiving signals which have been modulated according to several different modulation techniques.

Existing receivers are implemented using double conversion (or heterodyne) receiver architectures. A double conversion receiver architecture is characterized in that the received radio-frequency (RF) signal is converted to an intermediate frequency (IF) signal, which is subsequently converted to baseband. In addition, typically gain control is also applied at the IF. However, double conversion receivers have the disadvantage of utilizing a great number of analog circuit components, thus, increasing the cost, size and power consumption of the receiver.

A direct conversion receiver, also sometimes called zero-IF receiver, provides an alternative to the traditional double down conversion architecture. This is particularly attractive for the use in wireless systems, especially in handsets since direct conversion receivers lend themselves more easily to monolithic integration than heterodyne architectures. Also, direct conversion exhibits immunity to the problem of image since there is no IF.

However, there exists design issues associated with the direct conversion architecture. The most serious problem is direct current (DC) offset in the baseband, which appears in the middle of the down-converted signal spectrum, and may be larger then the signal itself. This phenomenon is caused by local oscillator leakage and self-mixing. Furthermore, I/Q mismatch, occurring in the quadrature down-conversion can lead to corrupted signal constellation, and hence increasing the number of bits in error, due to the differences which may occur in the I and Q signal amplitudes.

FIG. 1 and FIG. 2 together illustrate the functioning of a conventional analog-to-digital converter (ADC or A/D) using a bandpass-sampling technique, to demodulate and digitize the in-phase and quadrature components of an RF signal. In particular, FIG. 1 is a schematic diagram that illustrates an exemplary receiver topology, and FIG. 2 illustrates the timing of the analog-to-digital demodulation and digitization. FIG. 3 is a schematic diagram that illustrates the functioning of a conventional prior-art bandpass-sampling delta-sigma analog-to-digital demodulator (BS-ADD).

Referring now to FIG. 1, the schematic diagram illustrating an exemplary conventional prior-art circuit for bandpass-sampling, demodulating, and digitizing the in-phase and quadrature components of an RF signal to the respective in-phase and quadrature digital signals will be discussed and described. A received RF signal typically comprises two distinct components: the low-frequency in-phase and quadrature signals that contain the communicating information, and an RF carrier.

The in-phase and quadrature signals, also referred to as modulating signals, are up-converted to the RF carrier frequency before being transmitted through the transmission media. The function of the communication receiver is to down-convert—or commonly said ‘demodulate’—the modulating signals down to baseband so that the communicating information can be decoded.

As shown in FIG. 1, the receiver circuit includes a receive antenna 101, a low noise amplifier (LNA) 103, a sample and hold (S/H) circuit 105, a S/H circuit 105, an ADC 109, and an ADC 111. Reception of a wireless RF communicating signal occurs at the antenna 101, after which the LNA 103 subsequently amplifies the received RF signal.

The S/H circuits 105 and 107 are configured to sample and hold the received RF, and to then provide the sampled and held signals to the ADCs 109 and 111, respectively. The S/H circuit 105 and the ADC 109 are driven by an in-phase sampling clock (SAMPLING CLOCK-I), while The S/H circuit 107 and the ADC 111 are driven by a quadrature sampling clock (SAMPLING CLOCK-Q) that is exactly ninety degree phase-shifted with respect to the in-phase sampling clock. The frequency of the in-phase sampling clock and the quadrature phase sampling clock is equal to the RF carrier frequency, which leads to a down-conversion technique known as ‘bandpass sampling.’

The ADC 109 provides an in-phase digital output signal representing the modulating in-phase analog signal, I, down-converted from the RF carrier frequency to baseband. The ADC 111 provides a quadrature digital output signal representing the modulating quadrature analog signal, Q, down-converted to baseband.

Referring now to FIG. 2, a timing diagram useful for illustrating an operation of the bandpass-sampling and down-converting in accordance with FIG. 1 will be discussed and described. FIG. 2 illustrates a sinusoidal waveform 201 of the RF carrier frequency, whose frequency is commonly in the gigahertz (GHz) range. For example, conventional cellular phone carrier frequencies are currently set at either 900 MHz or 1800 MHz.

The in-phase and quadrature signals which carry the communicating information modulate slowly the amplitude and/or the phase of the RF carrier depending on the modulation scheme employed in the communication system. When the sampling clock frequency of the ADCs 109 and 111 is much greater than the carrier frequency, the ADCs 109 and 111 will capture and digitize the sinusoidal waveform 201 of the carrier as well as the modulating in-phase and quadrature components. However, when the ADC sampling clock is equal to the RF carrier frequency, both ADC 109 and 111 will skip the sinusoidal waveform 201 and provide only two respective sampled data points every period of the RF carrier. ADC 109 will provide data points I₁, I₂, . . . , I_{N}, while ADC 111 will provide data points Q₁, Q₂, . . . , Q_{N}. In this case, the sampling effect is commonly referred to as ‘bandpass-sampling.’

ADC 109 provides a digital signal that is slowly varying with time as compared to the fast time-varying sinusoid 201, and represents the in-phase component of the signal that carries the communicating information. On the other hand, ADC 111 provides the quadrature component of the signal that carries the communicating information. When the ADCs 109 and 111 sampling clocks are lower than the RF carrier frequency (e.g., N times lower), each ADC will capture one sampled data every N periods of the RF carrier, outputting the same modulating signal as in the bandpass sampling technique. The sampling technique, in this case, is referred to as ‘sub-sampling’ or ‘under-sampling’. As long as the sub-sampling clock frequency is larger than twice the bandwidth of the in-phase and quadrature signals, no information is lost. In effect, a direct quadrature down-conversion (also called quadrature demodulation) is achieved in a communication receiver using two bandpass-sampling (or sub-sampling) ADCs.

Nevertheless, the current advance in technology limits usage of this architecture at RF frequencies. The inherent clock jitter in the ADC 109 and 111 sampling clocks (UNDER-SAMPLING CLOCK-I, and UNDER-SAMPLING CLOCK-Q), due to thermal agitation at the molecule level that generates phase noise in clock oscillators, limits severely the analog-to-digital conversion resolution of the sub-sampling ADCs. Clock phase noise is converted into digital noise at the output of the ADCs 109 and 111 and considerably reduces the signal-to-noise (SNR) of the receiver system, failing the communication system. A 12-bit resolution, as required by many communication standards nowadays, is not achievable using the bandpass-sampling topology as illustrated in FIG. 1.

Another prior-art technique has attempted to increase the conversion resolution by adding a feedback and a bandpass filter/amplifier in the loop, as illustrated in FIG. 3. This technique is referred to as bandpass-sampling delta-sigma analog-to-digital demodulation, or BS-ADD.

As shown in FIG. 3, the BS-ADD Includes a subtractor 303, an RF bandpass filter/amplifier 305, an N-bit A/D, a feedback multiplier 311, and an N-bit digital-to-analog converter (DAC or D/A) 307. The subtractor 303 subtracts a feedback signal from the RF signal to generate a modified RF signal.

The bandpass filter/amplifier 305 performs a bandpass filtering/amplification process on the modified RF signal from the subtractor 303 to generate a filtered RF signal. The center frequency of the bandpass filter/amplifier 305 is chosen to coincide with the RF carrier frequency, and its bandwidth is a fraction of the center frequency, that is typically a few mega-hertz (MHz) about the carrier frequency. The increase in the overall converter resolution is achieved by the feedback loop and the high-gain bandpass filter 305 to push the quantization noise out of the modulating signal band—also known as delta-sigma technique. The signal-to-noise ratio (SNR) in the modulating signal band is therefore increased, thereby increasing the theoretical the resolution of the BS-ADD beyond 12 bits.

The BS-ADD 301, as illustrated in FIG. 3, typically employs a low-resolution (less than 5 bits) N-bit A/D 309 operating in a bandpass-sampling mode. The N-bit A/D 309 down-converts the modulating signal, which carries the communicating information, from the RF carrier down to baseband.

The multiplier 311 is employed in the feedback loop to make the feedback path that contains the N-bit D/A 307 to push the quantization noise from the N-bit A/D 309 out of the modulating signal band and increase the overall conversion resolution. Since the N-bit A/D 309 output carries the demodulated signal, the latter must be up-converted to the RF carrier frequency so that a proper error signal can be generated from the difference between the input RF signal and the feedback signal at the feedback summer 303. The up-conversion of the N-bit A/D 309 output signal back to the RF carrier frequency is done by multiplying a demodulated signal from the N-bit A/D 309 with a periodic signal—as performed by the multiplier 311. The frequency of the periodic signal is equal to the RF carrier frequency. The BS-ADD 301 combines the delta-sigma technique with the bandpass-sampling technique to increase the overall converter resolution to beyond 12 bits.

To achieve quadrature down conversion, two BS-ADDs are required, which increases power consumption and cost. The first BS-ADD is used to down-convert the in-phase component of the RF signal, while the second BS-ADD is used to down-convert the quadrature component.

Thus, prior-art communication receivers demand heavy analog pre-processing of the received signal before conversion to the digital domain by an ADC. Improvements are sought to minimize the analog pre-processing by demodulating and digitizing directly the received signal in a communication receiver at RF.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a schematic diagram illustrating a conventional prior art circuit for sampling, demodulating and converting the in-phase and quadrature analog signals to the respective in-phase and quadrature digital signals;

FIG. 2 is a timing diagram useful for illustrating an operation of the sampling and converting in accordance with FIG. 1;

FIG. 3 is a schematic diagram illustrating another conventional prior art circuit for demodulating a RF signal and converting it to a digital signal;

FIG. 4 is a schematic diagram illustrating an exemplary quadrature bandpass-sampling analog-to-digital demodulator (QBS-ADD) in accordance with one or more embodiments;

FIG. 5 is a schematic diagram illustrating an alternative exemplary QBS-ADD in accordance with one or more embodiments;

FIG. 6 is a schematic diagram illustrating portions of the alternative exemplary QBS-ADD of FIG. 5 in more detail;

FIG. 7 is a schematic diagram illustrating another alternative exemplary QBS-ADD in accordance with one or more embodiments;

FIG. 8 is a schematic diagram illustrating portions of the alternative exemplary QBS-ADD of FIG. 7 in more detail;

FIG. 9 is a schematic diagram illustrating an exemplary clock generation portion of the QBS-ADD in accordance with one or more embodiments;

FIG. 10 is a schematic diagram illustrating an alternative exemplary clock generation portion of the QBS-ADD in accordance with one or more embodiments;

FIG. 11 is a schematic diagram illustrating an exemplary communication receiver utilizing a QBS-ADD, in accordance with various exemplary embodiments;

FIG. 12 is a schematic diagram of an exemplary communication receiver configured as a wideband IF receiver, in accordance with various exemplary embodiments; and

FIG. 13 is a schematic diagram illustrating an exemplary multi-band communication receiver using a plurality of QBS-ADDs, in accordance with various exemplary embodiments.

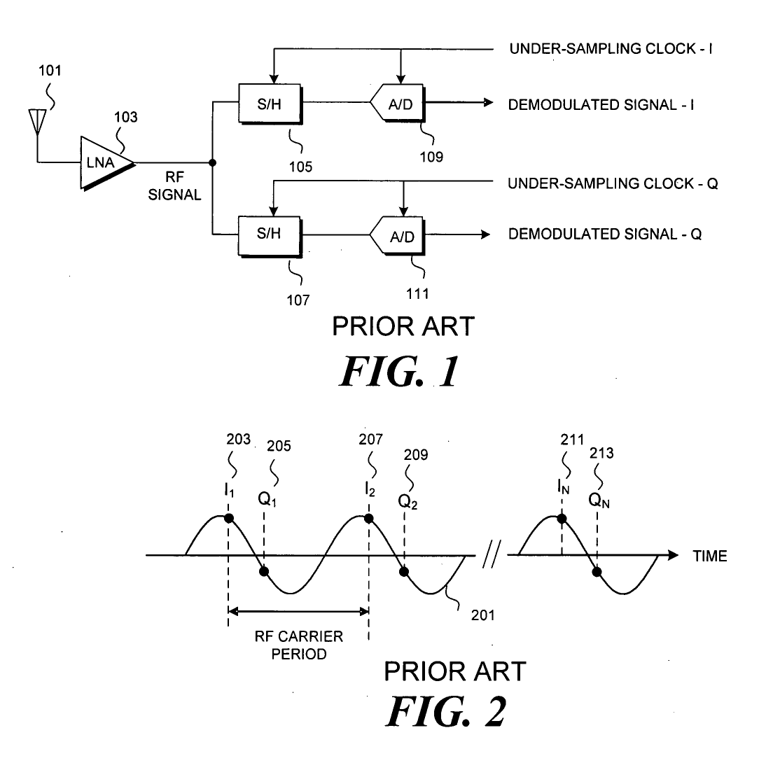

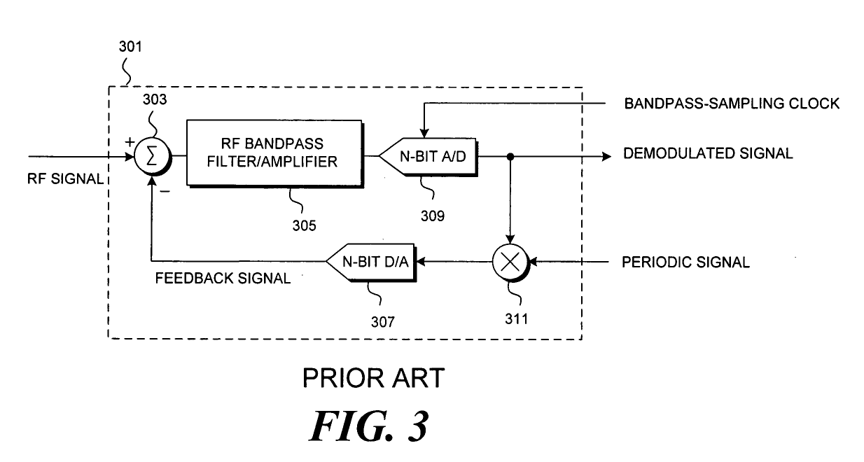

### DETAILED DESCRIPTION

In overview, the present disclosure concerns electronic devices or units, some of which are referred to as communication units, such as cellular phone or two-way radios and the like, typically having a capability for rapidly handling data, such as can be associated with a communication system such as an Enterprise Network, a cellular Radio Access Network, or the like. More particularly, various inventive concepts and principles are embodied in circuits, and methods therein for receiving signals in connection with a communication unit.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to simplify and minimize the analog components in a communication receiver, thereby lower the power consumption and part cost, and yet provide unprecedented performance by demodulating and digitizing the RF signal at the carrier frequency directly to baseband or a low-frequency digital IF.

Further in accordance with exemplary embodiments, there is provide an analog-to-digital demodulator employing the quadrature bandpass-sampling technique with feedback, which will be often referred to as QBS-ADD in later exemplary embodiments. One or more embodiments provide usage of the bandpass-sampling technique to down-convert the RF signal. Furthermore, a novel feedback technique is employed in the QBS-ADD according to various exemplary embodiments to produce high analog-to-digital conversion resolution.

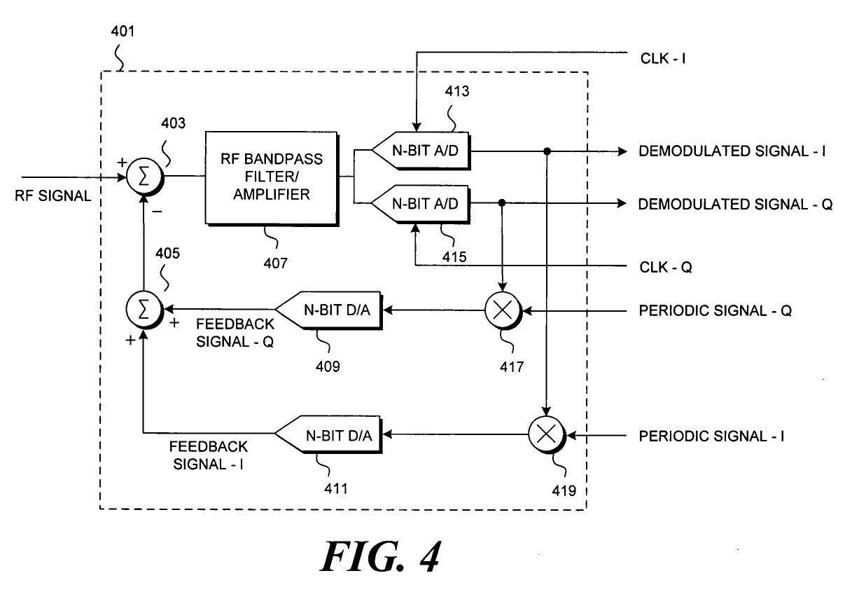

Referring now to FIG. 4, a schematic diagram illustrating an exemplary quadrature bandpass-sampling delta-sigma technique in accordance with one or more embodiments will be discussed and described. This technique provides multiple feedback loops from the demodulated I and Q signals to the received RF signal. The illustrated embodiment in FIG. 4 is referred to as ‘quadrature bandpass-sampling delta-sigma analog-to-digital demodulator’ or QBS-ADD for short. As shown in FIG. 4, the QBS-ADD 401 includes a subtractor 403, an RF bandpass filter/amplifier 407, an N-bit A/D 413, an N-bit A/D 415, a feedback multiplier 417, a feedback multiplier 419, an N-bit D/A 409, an N-bit D/A 411, and an adder 405.

In FIG. 4, an RF signal is provided to the subtractor 403. This RF signal is assumed coming from an LNA connected to an antenna. The bandpass filter/amplifier 407 performs a bandpass filtering/amplification process on the modified RF signal from the subtractor 403 to generate a filtered RF signal. The center frequency of the bandpass filter/amplifier 407 is chosen to coincide with the RF carrier frequency, and its bandwidth is a fraction of the center frequency, that is typically a few mega-hertz (MHz) about the carrier frequency. The N-bit A/Ds 413 and 415 receive an output of the bandpass filter/amplifier 407, and are sub-sampled by two clocks, CLK-I and CLK-Q, in quadrature, i.e., the phases of CLK-I and CLK-Q are offset by ninety degrees from each other.

The quadrature bandpass-sampling technique allows down-conversion of both in-phase and quadrature components of the RF SIGNAL. The DEMODULATED SIGNAL-I and DEMODULATED SIGNAL-Q output from the N-bit A/Ds 413 and 415, respectively, are up-converted to the RF frequency by the multipliers 417 and 419. Multiplier 417 mixes the demodulated signal-I with the PERIODIC SIGNAL-I; and multiplier 419 mixes the DEMODULATED SIGNAL-Q with the PERIODIC SIGNAL-Q. The outputs of multipliers 417 and 419 are converted to the analog FEEDBACK SIGNAL-Q and the analog FEEDBACK SIGNAL-I by the N-bit D/As 409 and 411, respectively.

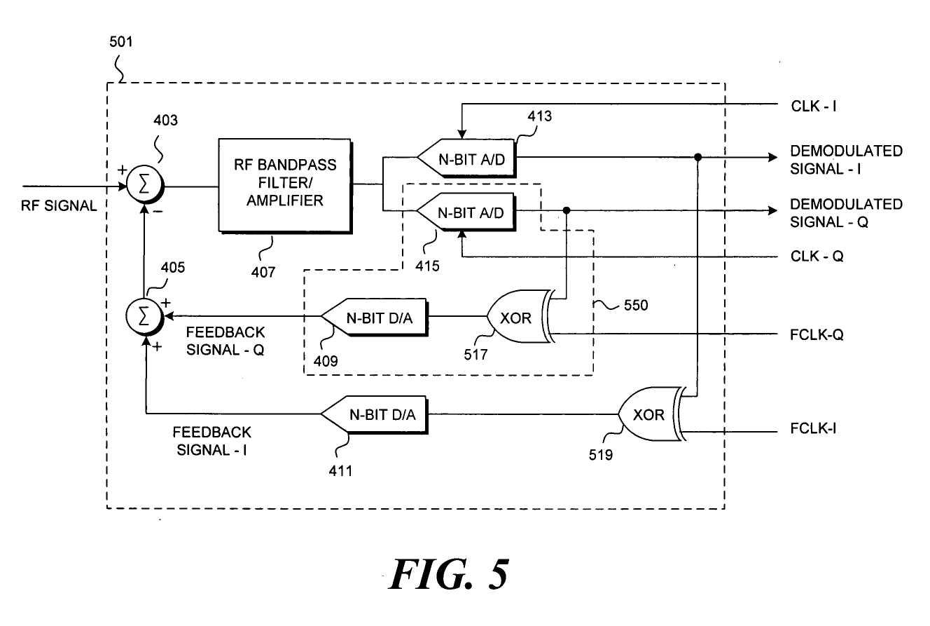

Referring now to FIG. 5, a schematic diagram illustrating an alternative exemplary quadrature bandpass-sampling delta-sigma analog-to-digital demodulation in accordance with one or more embodiments will be discussed and described. The illustrated embodiment provides an alternative where the multipliers 417 and 419 in FIG. 4 are replaced by a plurality of Exclusive-OR (XOR) operators. By using bi-level digital clocks, FCLK-I and FCLK-Q as illustrated in FIG. 5, the XOR circuits 517 and 519 can replace the feedback multipliers 417 and 419 in FIG. 4. The QBS-ADD 501 in FIG. 5 is functionally equivalent to the QBS-ADD 401 in FIG. 4.

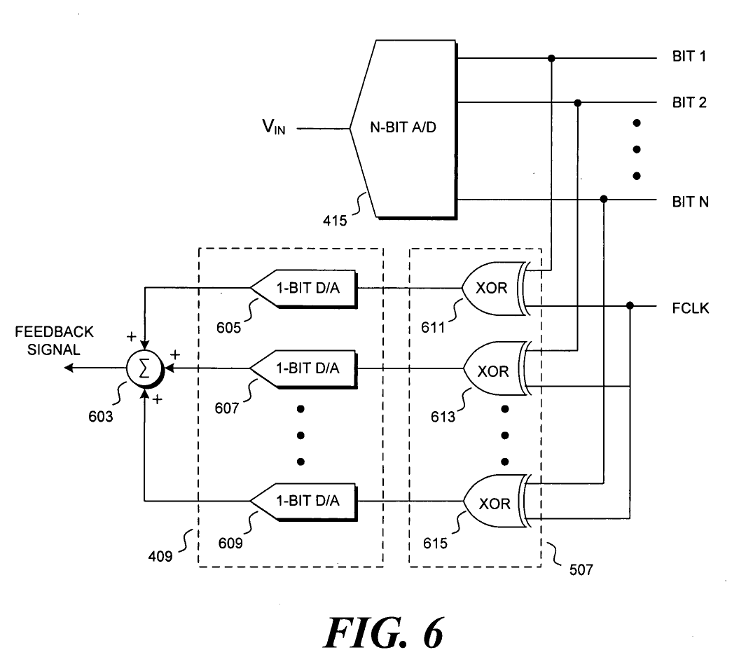

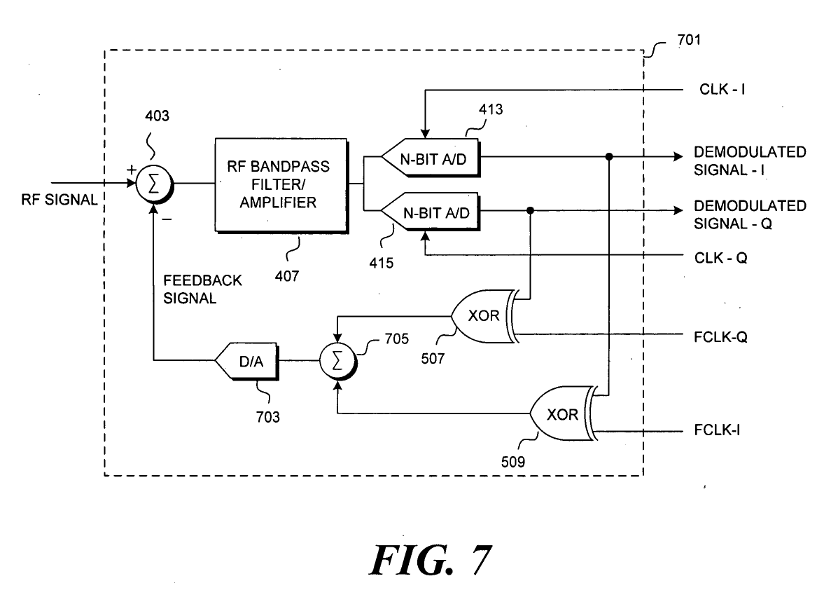

Referring now to FIG. 6, a schematic diagram illustrating portions of the exemplary QBS-ADD 501 in detail in accordance with one or more embodiments will be discussed and described. FIG. 6 illustrates the detail of circuit element 550 in FIG. 5, comprising the N-bit A/D 415, the XOR circuit 517, and the N-bit D/A 409. More specifically, the circuit element 550 includes the N-bit A/D 415, a plurality of individual XOR circuits 611, 613, . . . , 615, a plurality of 1-bit D/As 605, 607, . . . , 609, and a summer 603.

The N-bit ADC 415 receives an analog input voltage, VIN, and produces the respective N-bit digital outputs, BIT 1, BIT 2, . . . , BIT N. Each output bit of the ADC 415 is multiplied with the feedback clock, FCLK, by the XORs 611, 613, . . . , 615. The resulting digital outputs of the XORs 611, 613, . . . , 615 are converted to their respective analog signals by the 1-bit DACs 605, 607, . . . , 609, respectively. The DAC analog output signals are summed together by the summer 603 producing the analog FEEDBACK SIGNAL-Q of component 550 in FIG. 5. Similarly, the schematic in FIG. 6 also applies to a circuit element made up of the N-bit A/D 413, the XOR 519, and the N-bit D/A 411, which produces the analog FEEDBACK SIGNAL-I shown in FIG. 5.

Referring now to FIG. 7, a schematic diagram illustrating an alternative exemplary quadrature bandpass-sampling delta-sigma analog-to-digital demodulation in accordance with one or more embodiments will be discussed and described. The illustrated embodiment provides an alternative wherein the summer 405 in FIG. 5 adding the FEEDBACK SIGNAL-I and the FEEDBACK SIGNAL-Q is moved to the outputs of the XOR circuits 507 and 509. The resulting schematic is illustrated in FIG. 7, wherein the alternative QBS-ADD 701 comprises a digital summer 705 that precedes a D/A 703. Otherwise, the QBS-ADD 701 is functionally equivalent to the QBS-ADD 401 in FIG. 4.

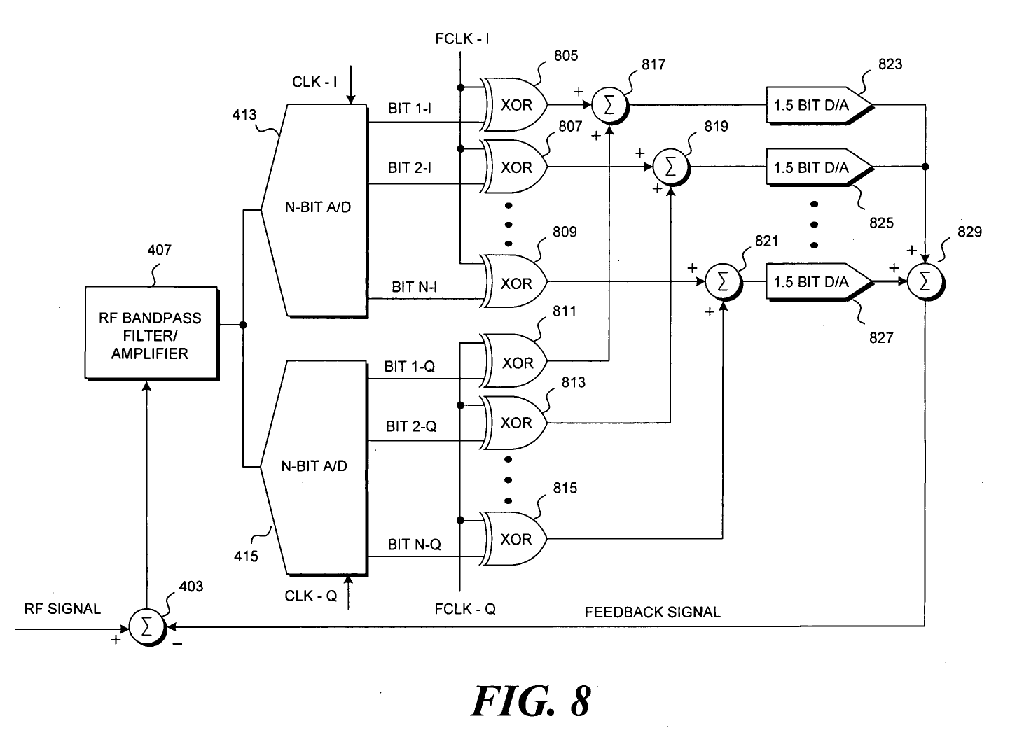

Referring now to FIG. 8, a schematic diagram illustrating the exemplary QBS-ADD 701 in detail in accordance with one or more embodiments will be discussed and described. The N-bit A/D 413 (for the in-phase path) and the N-bit A/D 415 (for the quadrature path), each of which receives an analog voltage from the bandpass filter/amplifier 407 and produce a respective N-bit digital output, BIT 1, BIT 2 . . . , BIT n. Each output bit of the N-bit A/D 413 is multiplied with the feedback clock, FCLK-I, by the XOR circuits 805, 807, . . . , 809. Likewise, each output bit of the N-bit A/D 415 is multiplied with the feedback clock, FCLK-Q, by the XOR circuits 811, 813, . . . , 815.

The XOR output responsive to an input bit from the N-bit A/D 413 is added to the XOR output responsive to an input bit of the same order from the N-bit A/D 415; namely, the XOR 805 output is added to the XOR 811 output by the summer 817, the XOR 807 output is added to the XOR 813 output by the summer 819, up through all of the bits until the XOR 809 output is added to the XOR 815 by the summer 821, respectively.

Since each XOR output has a one-bit value, the summation of two XOR outputs results in a three-level digital output (i.e., 0+0=0, 0+1=1+0=1, and 1+1=2), or equivalently a 1.5-bit digital output. 1.5-bit DACs 823, 825, 827 convert the 1.5-bit outputs of the summer 817, 819, and 821, respectively, to three analog signals that are summed together by a summer 829 producing the FEEDBACK SIGNAL to the feedback summer 403.

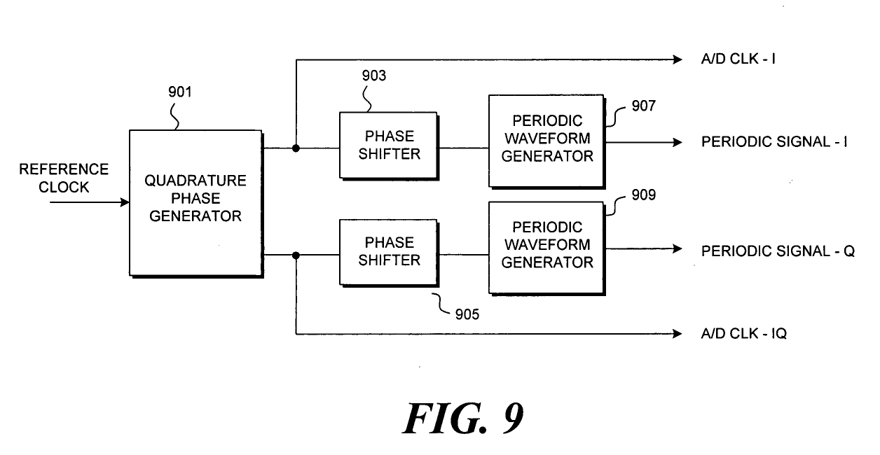

Referring now to FIG. 9, a schematic diagram illustrating portions of the exemplary QBS-ADD in FIG. 4 and the alternative exemplary embodiments in FIG. 5 and FIG. 7. The ADC sampling clocks, CLK-I and CLK-Q, the PERIODIC SIGNAL-I, and the PERIODIC SIGNAL-Q have the same frequency, all of which are derived from a REFERENCE CLOCK. As shown in FIG. 9, a quadrature phase generator 901 is employed to produce the A/D CLK-I and the A/D CLK-Q, which are ninety degree out of phase respective to each other. A periodic waveform generator 907 and a phase shifter 903 in tandem will produce a PERIODIC SIGNAL-I that is phase-shifted respective to the A/D CLK-I. Likewise, a periodic waveform generator 909 and a phase shifter 905 in tandem will produce the PERIODIC SIGNAL-Q hat is phase-shifted respective to the A/D CLK-Q.

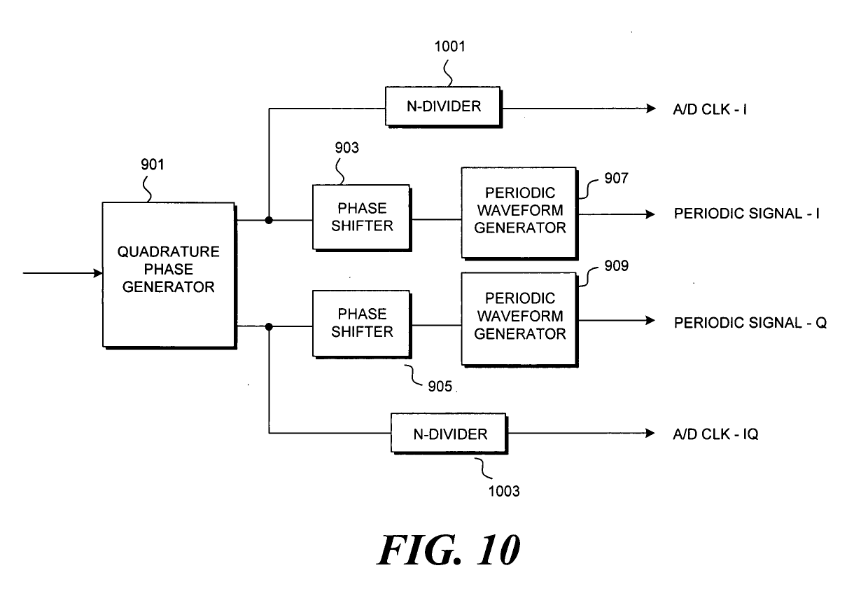

Referring now to FIG. 10, a schematic diagram illustrating alternative portions of the exemplary QBS-ADDs in FIG. 4, FIG. 5, and FIG. 7. As shown in FIG. 10, a divide-by-N frequency divider 1001 divides the first output of the quadrature phase generator, producing an A/D CLK-I that is N times smaller than the REFERENCE CLOCK frequency (where N is a positive integer). Likewise, a divide-by-N frequency divider 1003 divides the second output of the quadrature phase generator producing an A/D CLK-Q that is also N times smaller than the REFERENCE CLOCK frequency. Referring to FIG. 2, under-sampling in this case demodulates and digitizes only two data points 203 and 205 of the carrier waveform 201 every N periods. As long as the sub-sampling ADC clocks, A/D CLK-I and A/D CLK-Q, are larger than twice the Nyquist bandwidth of the in-phase and quadrature signals, no information is lost in the receiving.

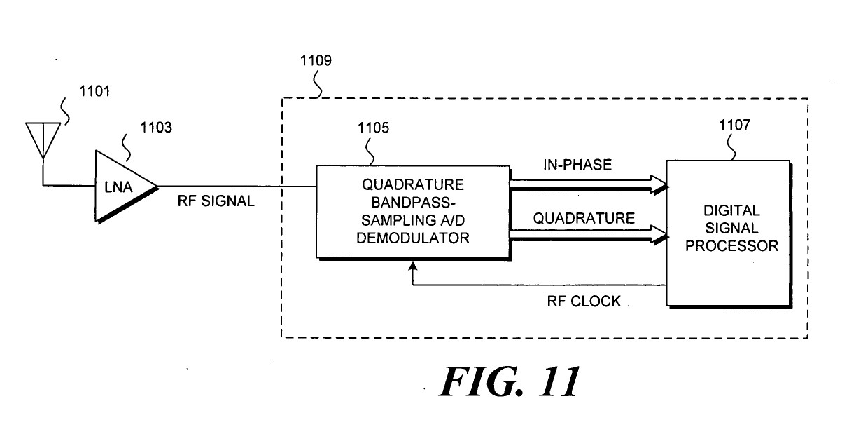

Referring now to FIG. 11, a functional block diagram illustrating an exemplary communication receiver 1109 arranged for receiving data using a quadrature bandpass sampling A/D demodulator (QBS-ADD), in accordance with various exemplary embodiments will be discussed and described.

As shown in FIG. 11, reception of a wireless communicating signal is done at the antenna 1101. An LNA 1103 is then employed to amplify the received signal to produce an RF SIGNAL to the communication receiver 1109. A QBS-ADD 1105 in the communication receiver 1109 receives an RF CLOCK from a digital signal processor 1107, demodulates and digitizes the RF SIGNAL to produce an IN-PHASE signal and a QUADRATURE signal, both carrying the communicating information. The IN-PHASE and QUADRATURE digital signals are then further processed by the digital signal processor 1107.

The RF CLOCK can have the same frequency as the RF SIGNAL frequency, and the demodulation is then referred to as ‘direct conversion’. At the same token, the RF CLOCK can have a frequency that is higher or than the RF SIGNAL frequency, and the demodulation is referred to as ‘intermediate frequency (IF) conversion’.

The communication receiver 1109 can be configured as a wideband direct-conversion receiver, wherein the RF CLOCK in FIG. 11 will have the same frequency as the RF SIGNAL frequency. To configure the receiver 1109 as a wideband receiver, the RF CLOCK frequency can be programmed by the digital signal processor 1107 to span various frequency bands. As a consequence, the center frequency of the RF bandpass filter 407 in FIGS. 4, 5, and 7 must be tunable in accordance with the setting of the RF CLOCK from the digital signal processor 1107.

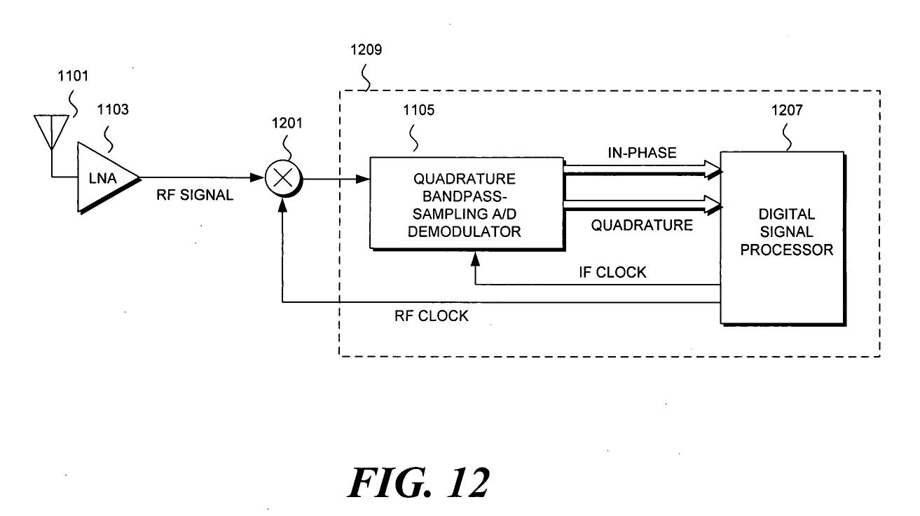

Referring now to FIG. 12, a functional block diagram illustrating an alternative exemplary communication receiver 1209 configured as a wideband IF receiver, in accordance with various exemplary embodiments will be discussed and described. As shown in FIG. 12, the disclosed embodiment is similar to that of FIG. 11, except that a mixer 1201 prior to the QBS-ADD.

In the embodiment of FIG. 12, a digital signal processor (DSP) 1207 generates both an RF CLOCK and an IF clock. The IF CLOCK preferably has a fixed frequency; thereby removing the tunability requirement on the center frequency and simplifying the design of the RF bandpass filter 407 in FIGS. 4, 5 and 7. To achieve wideband reception of RF signals, the mixer 1201 is added before the communication receiver 1209 to perform frequency-translation of RF input signals to the frequency of the IF CLOCK. The RF CLOCK input to the mixer 1201 is programmed by the digital signal processor 1207 to perform IF-frequency translation from any given RF SIGNAL frequency.

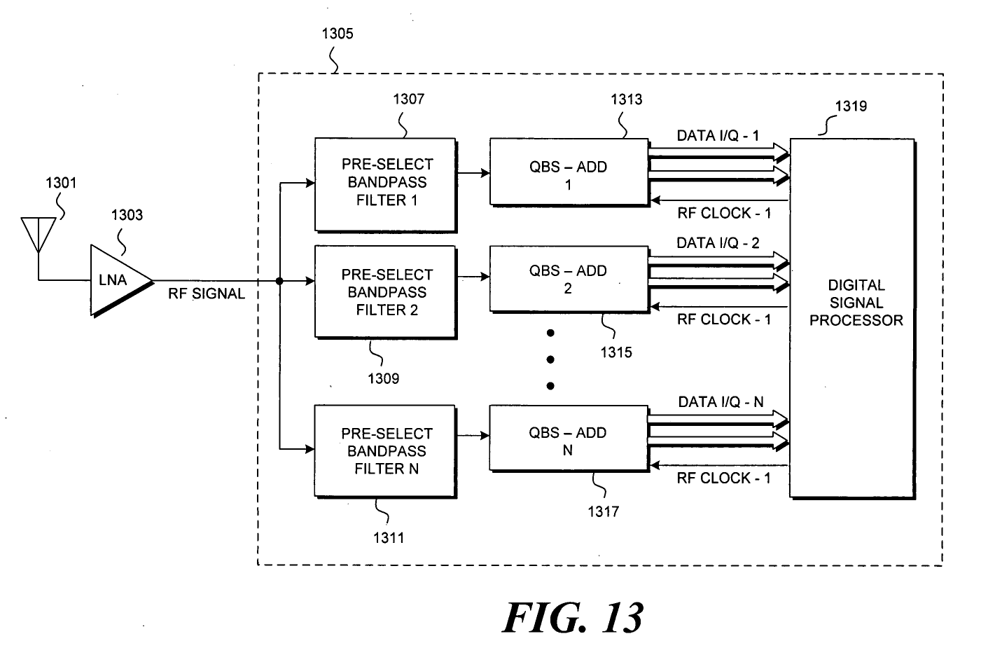

Referring now to FIG. 13, a functional block diagram illustrating an alternative exemplary communication receiver arranged for receiving data simultaneously at multiple RF bands, in accordance with various exemplary embodiments will be discussed and described. As with the embodiment of FIG. 11, an antenna 1101 receives the communicating signal, and an LNA 1103 amplifies the incoming signal to produce an RF SIGNAL.

As shown FIG. 13, a communication unit 1305 is provided as a multi-band digital receiver, wherein a plurality of QBS-ADDs, including units 1313, 1315, . . . , 1317, are used in parallel configuration. In this embodiment pre-select bandpass filters 1307, 1309, . . . , 1311 are needed to separate various components of the RF SIGNAL belonging to different frequency bands. The digital signal processor 1319 generates multiple RF clock signals, RF CLOCK 1, RF CLOCK 2, . . . , RF CLOCK N, each of which corresponds to a pre-determined receiving RF band.

The digital signal processors 1107 in FIG. 11, 1207 in FIGS. 12 and 1319 in FIG. 13 may comprise one or more microprocessors and/or one or more digital signal processors. The digital signal processors may also represent a large-scale computer or the like comprising a read-only memory (ROM), a random-access memory (RAM), a programmable ROM (PROM), and/or an electrically erasable read-only memory (EEPROM). They may include multiple memory locations for storing, among other things, an operating system, data and variables for programs executed by the processors; computer programs for causing the processors to operate in connection with other various functions such as receiving data, digital filtering, digital signal processing and/or other processing.

It should be noted that the term communication unit may be used herein to denote a wired device, for example a high speed modem, an xDSL type modem, a fiber optic transmission device, and the like, and a wireless device, and typically a wireless device that may be used with a public network, for example in accordance with a service agreement, or within a private network such as an enterprise network or an ad hoc network. Examples of such communication devices include a cellular handset or device, television apparatus, personal digital assistants, personal assignment pads, and personal computers equipped for wireless operation, and the like, or equivalents thereof, provided such devices are arranged and constructed for operation in connection with wired or wireless communication.

The communication units of particular interest are those providing or facilitating voice communications services or data or messaging services normally referred to as ultra wideband networks, cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore, the wireless communication devices of interest may have short range wireless communications capability normally referred to as WLAN (wireless local area network) capabilities, such as IEEE 802.11, Bluetooth, WPAN (wireless personal area network) or Hiper-Lan and the like using, for example, CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication devices of interest may be connected to a LAN using protocols such as TCP/IP, UDP/UP, IPX/SPX, or Net BIOS via a hardwired interface such as a cable and/or a connector.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A circuit for processing a radio frequency signal, comprising:
a subtractor configured to receive the radio frequency signal and a unified feedback signal, and to produce an error signal responsive to a difference between the radio frequency signal and the feedback signal;
a bandpass filter and amplifier, configured to receive the error signal, and to perform a filtering and amplification process on the error signal to produce a bandpassed and amplified error signal;
a first analog-to-digital converter configured to receive the amplified error signal and a first sampling clock, and to produce a first digital demodulated signal responsive to the amplified error signal in accordance with the first sampling clock;
a second analog-to-digital converter configured to receive the amplified error signal and a second sampling clock, and to produce a second digital demodulated signal responsive to the amplified error signal in accordance with the first sampling clock;
a first multiplier configured to receive the first digital demodulated signal and a first periodic signal, and to produce a first digital feedback signal responsive to a multiplication of the first digital demodulated signal and the first periodic signal;
a second multiplier configured to receive the second digital demodulated signal and a second periodic signal, and to produce a second digital feedback signal responsive to a multiplication of the second digital demodulated signal and the second periodic signal;
a first digital-to-analog converter configured to convert the first digital feedback signal into a first analog feedback signal;
a second digital-to-analog converter configured to convert the second digital feedback signal into a second analog feedback signal; and
a feedback summer configured to add the first analog feedback signal to the second analog feedback signal to generate the unified feedback signal.

2. The circuit of claim 1,
wherein the first analog-to-digital converter has a first resolution of N bits,
wherein the second analog-to-digital converter has a second resolution of N bits, and
wherein N is a positive number.

3. The circuit of claim 1,
wherein the first digital-to-analog converter has a first resolution of N bits,
wherein the second digital-to-analog converter has a second resolution of N bits, and
wherein N is a positive number.

4. The circuit of claim 1, wherein the first multiplier comprises a plurality of exclusive-OR circuits configured to receive a plurality of first bits, respectively, from the first analog-to-digital converter and a respective periodic signal, and to produce a plurality of first feedback bits.

5. The circuit of claim 4, further comprising a plurality of one-bit digital-to-analog converters configured to respectively produce a plurality of first analog bit signals responsive to the plurality of first feedback bits.

6. The circuit of claim 4, further comprising an output summer configured to add the plurality of first analog bit signals to generate the first analog feedback signal.

7. The circuit of claim 4, wherein the plurality of first feedback bits are each added to a corresponding one of a plurality of second feedback bits in a bit-by bit addition to generate a plurality of three-level digital signals.

8. The circuit of claim 7, further comprising a plurality of three-level digital-to-analog converters configured to produce a plurality of intermediate analog signals responsive to the plurality of three-level digital signals.

9. The circuit of claim 8, further comprising an output summer configured to add the plurality of intermediate analog signals to generate the analog feedback signal.

10. The circuit of claim 1,
further comprising a quadrature phase generator configured to receive a reference clock, and to produce first and second output clocks that are ninety degree phase-shifted with respect to each other,
wherein the first output clock drives the first analog-to-digital converter, and
wherein the second output clock drives the second analog-to-digital converter.

11. The circuit of claim 10, further comprising:
a first phase shifter configured to shift a first phase of the first output clock to produce a first shifted clock;
a second phase shifter configured to shift a second phase of the second output clock to produce a second shifted clock;
a first periodic waveform generator configured to produce a first periodic signal based on the first shifted clock; and
a second periodic waveform generator configured to produce a second periodic signal based on the second shifted clock.

12. The circuit of claim 10, further comprising:
a first clock divider configured to divide down the first output clock by a positive integer factor to produce a first divided sampling clock; and
a second clock divider configured to divide down the second output clock by the positive integer factor to produce a second divided sampling clock.

13. The circuit of claim 10, wherein the frequency of the reference clock is greater than or equal to a frequency of the radio frequency signal.

14. The circuit of claim 10, wherein the frequency of the reference clock is less than or equal to a frequency of the radio frequency signal.

15. A method for demodulating and digitizing a radio frequency signal, comprising:
receiving the radio frequency signal;
receiving a feedback signal;
generating an error signal responsive to a difference between the radio frequency signal and the feedback signal;
generating an amplified error signal by bandpass-filtering and amplifying the error signal;
producing a responsive in-phase demodulated digital signal by bandpass-sampling and digitizing the amplified error signal using a first sampling clock;
producing a responsive quadrature demodulated digital signal by bandpass-sampling and digitizing the amplified error signal using a second sampling clock; and
generating the feedback signal based on the responsive in-phase demodulated digital signal and the responsive quadrature demodulated digital signal in response to a first feedback clock and a second feedback clock,
wherein the first sampling clock and the second sampling clock are separated from each other by ninety degrees of phase.

16. The method of claim 15, wherein the generating of the feedback signal comprises:
performing an exclusive-OR operation on each output bit of the responsive in-phase demodulated digital in accordance with a first feedback clock to produce a first responsive digital output signal;
performing an exclusive-OR operation on each output bit of the responsive quadrature demodulated digital in accordance with a second feedback clock to produce a second responsive digital output signal;
converting the first responsive digital output signal to a first responsive analog output signal;
converting the second responsive digital output signal to a second responsive analog output signal; and
adding first and second responsive analog output signals together to form the feedback signal.

17. The method of claim 15, wherein the generating of the feedback signal comprises:
generating a first plurality of exclusive-OR signals by successively performing exclusive-OR operations on first bits in the first responsive analog output signal with the first feedback clock;
generating a second plurality of exclusive-OR signals by successively performing exclusive-OR operations on second bits in the second responsive analog output signal with the second feedback clock; and
adding bits of the first plurality of exclusive-OR signals to corresponding bits of the second plurality of exclusive-OR signals to generate a plurality of three-level digital output signals.

18. The method of claim 17, further comprising:
converting the plurality of three-level digital output signals to a plurality of responsive analog signals; and
adding the plurality of responsive analog signals together to form the feedback signal.

19. The method of claim 15, wherein the bandpass sampling comprises under-sampling.

20. The method of claim 15, further comprising:
generating the first feedback clock, the first feedback clock being phase-shifted with respect to the first sampling clock; and
generating the second feedback clock, the second feedback clock being phase-shifted with respect to the second sampling clock.

21. The method of claim 15, further comprising generating the first and second converter sampling clocks such that they are shifted in phase ninety degrees with respect to each other.

22. A circuit for demodulating and digitizing said radio frequency signal in a communication receiving system, comprising:
one or more quadrature bandpass-sampling analog-to-digital demodulators arranged in parallel; and
a digital processor.

23. The circuit of claim 22, wherein the one or more quadrature bandpass-sampling analog-to-digital demodulators consists essentially of one quadrature bandpass-sampling analog-to-digital demodulator.

24. The circuit of claim 23, wherein
a mixer precedes the quadrature bandpass-sampling analog-to-digital demodulator, and
the frequency of the reference clock to the analog-to-digital demodulator is fixed, and
the frequency of the reference clock to the mixer is variable.

25. The circuit of claim 22, wherein a frequency of reference clock is less than or equal to a frequency of the radio frequency signal.

26. The circuit of claim 22, wherein a frequency of reference clock is greater than or equal to a frequency of the radio frequency signal.

27. The circuit of claim 22,
further comprising a plurality of pre-select bandpass filters in parallel configured to receive the radio frequency signal, each of plurality of pre-select bandpass filters preceding a quadrature bandpass-sampling analog-to-digital demodulator,
wherein reference clocks used for each quadrature bandpass-sampling analog-to-digital demodulators are not equal each other.
